(19) United States
(12) Patent Application Publication
(10) Pub. No.: US 2020/0230976 A1
(43) Pub. Date: Jul. 23, 2020

(54) IMAGE FORMING APPARATUS AND METHOD OF CONTROLLING THE SAME

(71) Applicant: Konica Minolta, Inc., Tokyo (JP)

(72) Inventors: Kazuko FUKUMOTO, Osaka (JP); Eiji TABATA, Osaka (JP); Makiko WATANABE, Uji-shi (JP)

(21) Appl. No.: 16/713,283

(22) Filed: Dec. 13, 2019

(30) Foreign Application Priority Data
Jan. 18, 2019 (JP) 2019-006784

(51) Int. Cl. B41J 11/00; B41J 2/01

(52) U.S. Cl. CPC B41J 11/002; B41J 2/01; B41J 11/007

(57) ABSTRACT

An image forming apparatus includes: a drying device that dries ink on a printing medium; a feeder that feeds, to the drying device, the printing medium on which an image is formed with ink; and a control device that controls the drying device and the feeder. The control device causes the drying device to perform: a first drying process of drying the image on the printing medium fed to the drying device; and, after the first drying process, a second drying process of applying vibrations to ink that forms the image.

The entire disclosure of Japanese Patent Application No. 2019-006784, filed on Jan. 18, 2019, is incorporated herein by reference in its entirety.

### BACKGROUND

### Technological Field

The present disclosure relates to drying of an image formed on a printing medium with discharged ink in an image forming apparatus.

### Description of the Related Art

An image forming apparatus such as a conventional multi-functional peripheral (MFP) is configured to dry an image formed with ink on a printing medium such as a print sheet and thereafter discharge the printing medium. Various methods have been proposed as a method of drying an image. For example, as a configuration of a drying unit of an ink jet type printer, Japanese Laid-Open Parent Publication No. 2014-233879 proposes: a configuration that brings a printing medium into contact with a heated roller; a configuration that brings a porous material into contact with the printing medium; a configuration that provides cold air and/or warm air to the printing medium; a configuration that dries an image with heat by irradiation with infrared rays or electromagnetic waves; a configuration that dries the image by irradiation with ultrasonic waves; and a configuration that absorbs moisture in the image by an absorbing mechanism.

### SUMMARY

For the image forming apparatus as described above, a technique for shortening the time period for drying an image formed with ink is required.

To achieve at least one of the above-mentioned objects, according to an aspect of the present invention, an image forming apparatus reflecting one aspect of the present invention comprises: a drying device that dries ink on a printing medium; a feeder that feeds, to the drying device, the printing medium on which an image is formed with ink; and a control device that controls the drying device and the feeder. The control device causes the drying device to execute: a first drying process of drying the image on the printing medium fed to the drying device; and, after the first drying process, a second drying process of applying vibrations to ink that forms the image.

According to another aspect of the present disclosure, a computer-implemented method of controlling an image forming apparatus is provided. The computer-implemented method includes: feeding, to a drying device, a priming medium on which an image is formed with ink; and, in the drying device, performing a first drying process of drying the image on the printing medium; and in the drying device, performing a second drying process of applying vibrations to ink that form the image after the first drying process.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram schematically showing an example of a changing manner of the state of a printing medium on which an image is formed with ink, according to the progress of drying.

FIG. 2 is a diagram schematically showing an example of the changing manner of the state of the printing medium on which an image is formed with ink, according to the progress of drying.

FIG. 3 is a diagram schematically showing an example of the configuration of an image forming apparatus.

FIG. 4 is a diagram showing the configuration of a drying device 900.

FIG. 5 is a diagram showing an example of a control block of an image forming apparatus 1.

FIG. 6 is a flowchart of a process performed for controlling the manner of drying in a second drying unit 920.

FIG. 7 is a diagram showing a result of comparison between the configuration shown in FIG. 4 and other configurations.

FIG. 8 is a diagram showing a modification of the configuration of drying device 900.

FIG. 9 is a diagram showing an example of a control block of the image forming apparatus including drying device 900 in FIG. 8.

FIG. 10 is a flowchart for control of drying in a second drying unit 920 in each of the examples in FIGS. 8 and 9.

FIG. 11 shows an example of a process of controlling ON/OFF of a heater in a second drying unit 920 in a modification (3).

FIG. 12 shows an example of a process of controlling ON/OFF of a heater in a second drying unit 920 in a modification (4).

### DETAILED DESCRIPTION OF EMBODIMENTS

Hereinafter, one or more embodiments of the present invention will be described with reference to the drawings. However, the scope of the invention is not limited to the disclosed embodiments.

In the following, one embodiment of an image forming apparatus will be described with reference to the accompanying drawings. In the following description, the same parts and components are denoted by the same reference characters. Their names and functions are also the same. Accordingly, the description thereof will not be repeated.

[1. Progress of Drying and State of Image]

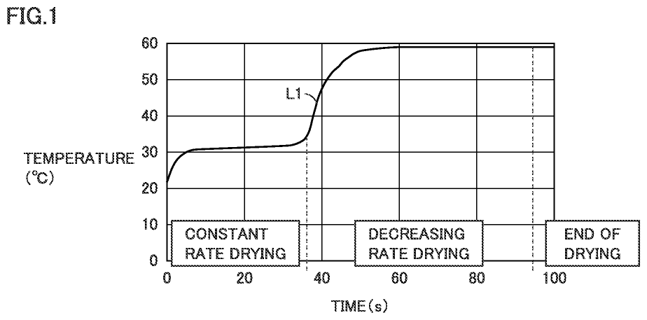

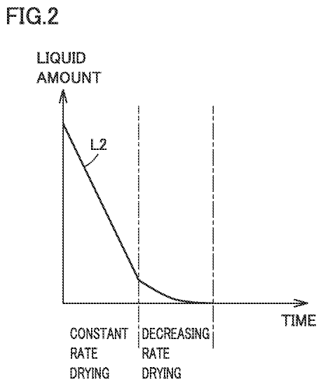

FIGS. 1 and 2 each schematically show an example of a changing manner of the state of a printing medium on which an image is formed with ink, according to the progress of drying. In FIG. 1, the horizontal axis shows a time period elapsed since start of drying while the vertical axis shows the surface temperature of the printing medium. A line L1 shows a temperature change of (ink that forms) an image according to the progress of drying in the case where heat is applied under an atmosphere of 58° C.

As shown by line L1, the surface temperature of the printing medium starts to abruptly rise from about 23° C. to about 30° C., and subsequently keeps gently rising for a while. Then, the surface temperature of the printing medium again abruptly rises to the atmosphere temperature. In FIG. 1, the time period from start of heating to the second temperature rise is staged as “constant rate drying”; the time period from the second temperature rise until the temperature is stabilized at an atmosphere temperature is staged as “decreasing rate drying”; and the subsequent state where the temperature is stabilized at the atmosphere temperature is staged as “end of drying”.

“Constant rate drying” is considered as a stage where the moisture on the surface of ink that forms an image evaporates. “Decreasing rate drying” is considered as a stage where the moisture existing between the solid components of ink evaporates.

It should be noted that the manner of the temperature change in each of stages of constant rate drying and decreasing rate drying shown in FIG. 1 is merely an example. Depending on the ink material, the temperature of ink may rise to the temperature close to the drying temperature in the stage of constant rate drying. In the case of such an ink material, the temperature of ink may already have risen to the temperature close to the drying temperature at the time of start of decreasing rate drying. Thus, even in the case of such an ink material, the temperature in the time period of constant rate drying, the temperature in the time period of decreasing rate drying, and the temperature close to the drying temperature are controlled while being sufficiently distinguished from one another. Thereby, the stages of “constant rate drying”, “decreasing rate drying”, and “end of drying” may be distinguished from one another.

In FIG. 2, the horizontal axis shows a time period elapsed since the start of drying as in FIG. 1 while the vertical axis shows the amount of liquid contained in the ink that forms an image. A line L2 shows a temporal change of the amount of liquid under the same situation as that in FIG. 1. “Constant rate drying” and “decreasing rate drying” in FIG. 2 have the same meanings as those shown in FIG. 1. As shown by line L2, in the stage of decreasing rate drying, the reduced amount of moisture over time is smaller than that in the stage of constant rate drying.

In the image forming apparatus of the present embodiment, the image is dried using ultrasonic wave vibrations in a time period in which the moisture content in the ink that forms an image on a printing medium is relatively reduced (a time period of decreasing rate drying). Thereby, the image may be dried at an early stage in the state where the image is less likely to be deformed by vibrations.

[2. Configuration of Image Forming Apparatus]

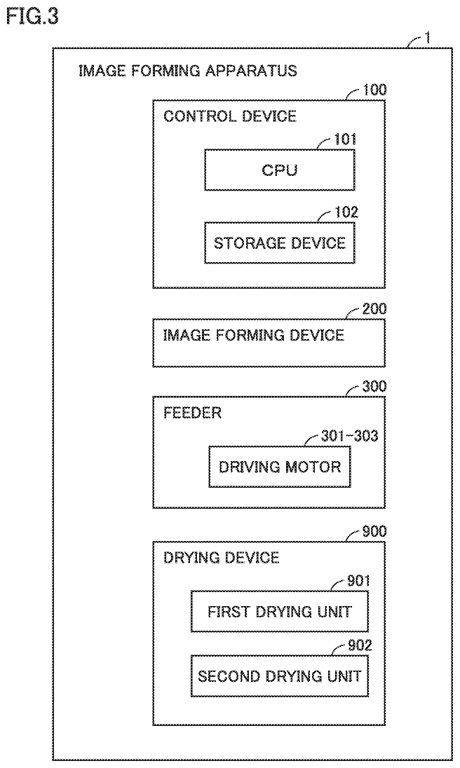

FIG. 3 schematically shows an example of the configuration of an image forming apparatus. As shown in FIG. 3, an image forming apparatus 1 includes a control device 100, an image forming device 200, a feeder 300, and a drying device 900.

Control device 100 entirely controls the operation of image forming apparatus 1. Control device 100 includes a central processing unit (CPU) 101 that executes a given program, and a storage device 102 in which the program is stored. It should be noted that the program executed by CPU 101 may be stored in any storage device (for example, a USB (Universal Serial Bus) memory, a storage device constituting another device on a network, and the like) external to image forming apparatus 1 as long as it is accessible from CPU 101.

Image forming device 200 forms an image with ink on a printing medium. By way of example, image forming apparatus 1 is a printer of an ink-jet type. Image forming device 200 includes a unit that discharges ink under control of control device 100.

Feeder 300 feeds a printing medium inside image forming apparatus 1, and includes driving motors 301 to 303 each for driving a roller (a feeding roller 951 and the like that will be described later) to be rotated for feeding a printing medium. By way of example, the printing medium is a sheet of copy paper. Image forming apparatus 1 includes a paper cassette in which sheets of copy paper are housed. Feeder 300 picks up sheets of copy paper one by one from the paper cassette, feeds each sheet of copy paper to image forming device 200, feeds each sheet of copy paper from image forming device 200 to drying device 900, and then discharges each sheet of copy paper onto a paper discharge tray. Another example of a printing medium may be a printing medium that is a resin film made of polypropylene (PP), polyethylene terephthalate (PET), polystyrene (PS) and the like as a material that is more likely to be influenced by heat than copy paper.

Copy paper is an example of a printing medium through which ink permeates. A resin film is an example of a printing medium through which ink does not permeate (an impermeable printing medium). Another example of the impermeable printing medium may be a printing medium including a base material having a surface that is pre-coated for temporary fixing (pinning) of colors or ink. In other words, the impermeable printing medium is a printing medium that is made of a material through which ink does not permeate (or through which ink is less likely to permeate).

Drying device 900 performs a plurality of processes for drying an image on a printing medium. In the example in FIG. 3, drying device 900 includes a first drying unit 910 for performing the first drying process, and a second drying unit 920 for performing the second drying process.

[3. Configuration of Drying Device]

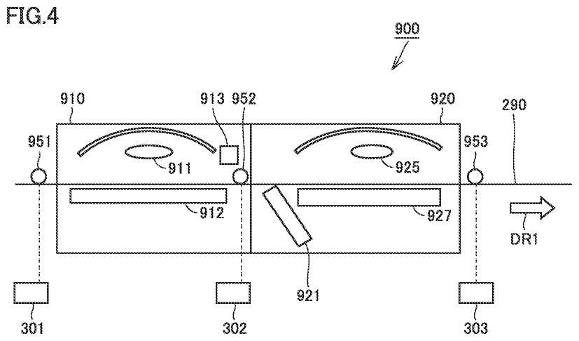

FIG. 4 shows the configuration of drying device 900.

As shown in FIG. 4, drying device 900 is provided with first drying unit 910 and second drying unit 920. An arrow DR1 shows the direction in which a printing medium is fed. A feeding path 290 represents a path along which the printing medium is fed.

Second drying unit 920 is disposed on the downstream side of first drying unit 910. In the preceding stage of first drying unit 910, a feeding roller 951 is installed for feeding, to first drying unit 910, the printing medium on which an image is formed by image forming device 200. Feeding roller 951 is rotated as it is driven by driving motor 301.

First drying unit 910 includes an upper heater 911, a lower heater 912, a temperature sensor 913, and a feeding roller 952. Upper heater 911 is implemented by a halogen heater, for example, while lower heater 912 is implemented by a sheet-shaped heater (for example, a silicone rubber heater), for example. Upper heater 911 and lower heater 912 heat the printing medium on the feeding path from above and below, respectively. First drying unit 910 dries the image on the printing medium with the heat emitted from upper heater 911 and lower heater 912. Temperature sensor 913 detects the temperature of the surface of the printing medium.

Feeding roller 952 feeds the printing medium from first drying unit 910 to second drying unit 920. Feeding roller 952 is rotated as it is driven by driving motor 302.

Second drying unit 920 includes an ultrasonic oscillator 921, an upper heater 925, and a lower heater 927. Ultrasonic oscillator 921 includes an ultrasonic vibrator such as a piezoelectric element and applies ultrasonic vibrations to the printing medium through feeding path 290, thereby drying the image on the printing medium. Ultrasonic oscillator 921 may include a configuration that oscillates an ultrasonic wave using other means such as an piezoelectric actuator. In second drying unit 920, the printing medium is heated in the stage subsequent to ultrasonic oscillator 921 by upper heater 925 and lower heater 927. Upper heater 925 is implemented by a halogen heater, for example, while lower heater 927 is implemented by a sheet-shaped heater, for example.

Feeding roller 953 feeds the printing medium from second drying unit 920 to the further downstream side in image forming apparatus 1. Feeding roller 953 is rotated as it is driven by driving motor 303.

[4. Control Block]

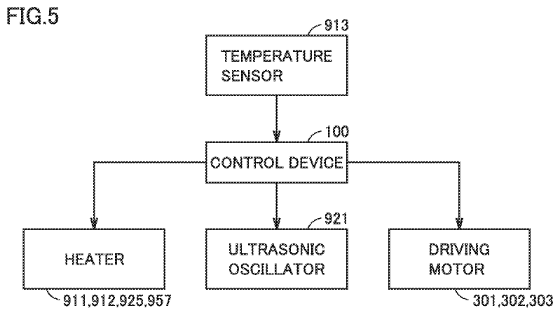

FIG. 5 shows an example of a control block of image forming apparatus 1. It should be noted that FIG. 5 shows a control block of only the portion related to drying of the image on the printing medium in drying device 900.

As shown in FIG. 5, temperature sensor 913 outputs a measurement result to control device 100. Control device 100 controls the operations of various types of heaters (upper heaters 911, 925 and lower heaters 912, 927), ultrasonic oscillator 921, and driving motors 301, 302 and 303.

[5. Control of Drying Device]

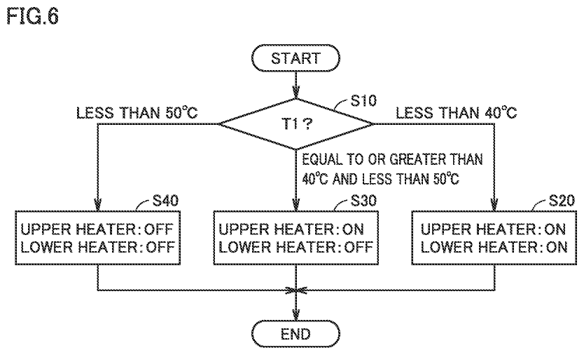

In image forming apparatus 1, drying device 900 causes first drying unit 910 to dry the image on the printing medium with heat, and subsequently, causes second drying unit 920 to dry the image on the printing medium by vibrations. It should be noted that image forming apparatus 1 causes second drying unit 920 to dry the image not only by applying vibrations but also by applying heat as required. FIG. 6 is a flowchart of the process performed by CPU 101 of control device 100 for controlling the manner of drying in second drying unit 920. For example, the process in FIG. 6 is implemented when CPU 101 executes a given program, and started when the leading end portion of the printing medium reaches a prescribed position in the vicinity of the outlet of first drying unit 910.

In step S10, CPU 101 checks a temperature T1 (the surface temperature of the printing medium) measured by temperature sensor 913. If temperature T1 is less than 40° C., CPU 101 causes the control to proceed to step S20. If temperature T1 is equal to or greater than 40° C. and less than 50° C., CPU 101 causes the control to proceed to step S30. If temperature T1 is equal to or greater than 50° C., CPU 101 causes the control to proceed to step S40.

In step S20, CPU 101 turns on upper heater 925 and lower heater 927. Thereby, in second drying unit 920, the image on the printing medium is dried not only by vibrations from ultrasonic oscillator 921 but also by heat from upper heater 925 and lower heater 927. Then, CPU 101 ends the process in FIG. 6.

In step S30. CPU 101 turns on upper heater 925, and turns off lower heater 927. Thereby, in second drying unit 920, the image on the printing medium is dried not only by vibrations from ultrasonic oscillator 921 but also by heat from upper heater 925. Then. CPU 101 ends the process in FIG. 6.

In step S40. CPU 101 turns off upper heater 925 and lower heater 927. Thereby, in second drying unit 920, the image on the printing medium is dried by vibrations from ultrasonic oscillator 921. Then, CPU 101 ends the process in FIG. 6.

In the above process described with reference to FIG. 6, as the temperature of the image on the printing medium discharged from first drying unit 910 is higher, less heat is utilized for drying the image on the printing medium in second drying unit 920. As having been described with reference to FIG. 1, as the image on the printing medium is dried more, the temperature of the image (ink) on the printing medium becomes higher. According to the process described with reference to FIG. 6, as the image on the printing medium is dried more, the quantity of heat utilized for drying the image on the printing medium in second drying unit 920 becomes smaller. Thereby, the heat supplied to the printing medium in second drying unit 920 can be reduced to the minimum possible level.

[6. Evaluation]

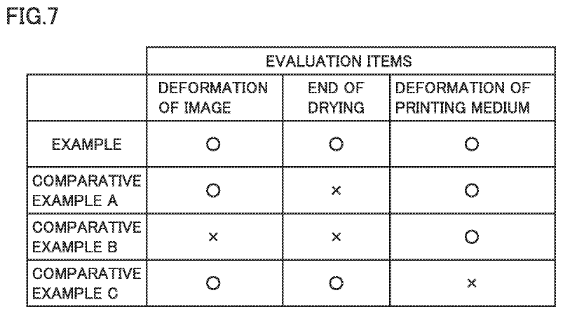

FIG. 7 is a diagram showing a result of comparison between the configuration shown in FIG. 4 and other configurations. FIG. 7 shows the result of three types of comparative examples (comparative examples A to C) together with an example. The example corresponds to the image obtained according to the configuration shown in FIG. 4 and the process shown in FIG. 6. Comparative examples A to C are as described below.

### COMPARATIVE EXAMPLES

Comparative example A: the configuration from which ultrasonic oscillator 921 is removed with reference to FIG. 4.

Comparative example B: the configuration in which first drying unit 910 is replaced with second drying unit 920 with reference to FIG. 4.

Comparative example C: the atmosphere temperature in each of the first drying unit and the second drying unit is 110° C. in comparative example A.

(Conditions)

The conditions common to the example and the comparative examples are as follows.

Feeding speed of the printing medium: 15 m/min

Liquid amount of ink in the image formed on the printing medium: 20 g/m²

Printing medium: a PET film having a thickness of 50 μm

Position of temperature sensor 913: on the upstream side by 10 cm from the boundary with second drying unit 920

Atmosphere temperature inside first drying unit 910: 60° C.

Warm air speed inside first drying unit 910 (from upstream to downstream: the surface of the printing medium): 5 m/sec

Temperature of upper heater 911 in first drying unit 910: 300° C. (halogen heater)

Temperature of lower heater 912 in first drying unit 910: 50° C. (silicone heater)

Atmosphere temperature inside second drying unit 920: 60° C.

Warm air speed inside second drying unit 920 (from upstream to downstream: the surface of the printing medium): 5 m/sec

Frequency of ultrasonic wave in second drying unit 920: 35 kHz

Temperature of upper heater 925 in second drying unit 920: 300° C. (halogen heater)

Temperature of lower heater 927 in second drying unit 920: 50° C. (halogen heater)

The wind velocity inside first drying unit 910 and the wind velocity inside second drying unit 920 are shown, for example, as values measured by an anemometer.

(Evaluation Items)

FIG. 7 shows the evaluations by the manufacturer of image forming apparatus 1 about the printing medium processed according to each example with regard to three types of evaluation items.

Deformation of image: “circle” (o) in case of no deformation in image; and “x” in case of deformation in image.

End of drying: “circle” (o) in case of no adhesion of ink onto a member rubbed against the surface of the image; and “x” in case of adhesion of ink onto a member rubbed against the surface of the image.

Deformation of printing medium: “circle” (o) in case of no deformation (warpage, shrinkage and the like) in the printing medium; and “x” in case of deformation in the printing medium.

In the example, the three types of evaluation items each were consequently marked as a “circle” (o). In contrast in comparative example A, the evaluation item “end of drying” wits consequently marked as “x”. These results show that the image was reliably dried due to application of ultrasonic vibrations in the example.

In comparative example B, the evaluation items “deformation of image” and “end of drying” each were consequently marked as “x”. These result show that the image is deformed due to application of vibrations to the image from the start of drying. Also according to the findings from the result, when drying by vibrations precedes drying by heat, the degree of dryness of the image is lower than that in the example in which drying by heat precedes drying by vibrations.

According to comparative example C, it turns out that, when the image is dried by high heat in place of heating by vibrations, the printing medium is deformed even though the image can be completely dried.

[7. Second Drying Unit Including Second Ultrasonic Oscillator]

(Drying Device)

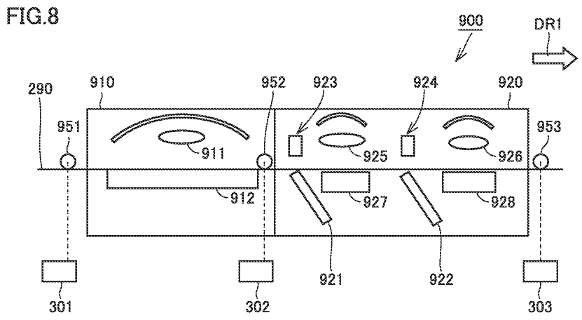

FIG. 8 shows a modification of the configuration of drying device 900. In the example in FIG. 8, second drying unit 920 further includes an ultrasonic oscillator 922 as compared with the example in FIG. 4. In other words, in the example in FIG. 8, second drying unit 920 can vibrates the printing medium in two stages.

As compared with second drying unit 920 in FIG. 4, second drying unit 921) in FIG. 8 further includes: a temperature sensor 923 for detecting the surface temperature of the printing medium that is vibrated by ultrasonic oscillator 921; and a temperature sensor 924 for detecting the surface temperature of the printing medium that is vibrated by ultrasonic oscillator 922.

As compared with second drying unit 920 in FIG. 4, second drying unit 920 in FIG. 8 further includes an upper heater 926 and a lower heater 928, each of which heats the printing medium that is vibrated by ultrasonic oscillator 922.

(Control Block)

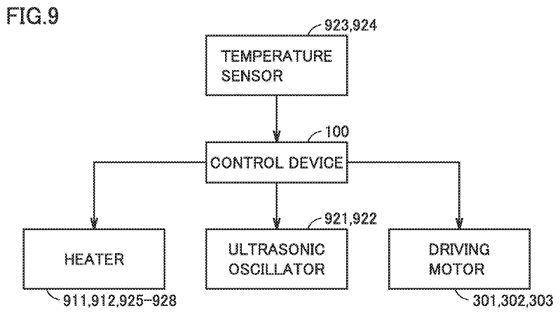

FIG. 9 shows an example of a control block of the image forming apparatus including drying device 900 in FIG. 8. In the example in FIG. 9, each of temperature sensors 923 and 924 outputs a measurement result to control device 100. Control device 100 controls the operations of various types of heaters (upper heaters 911, 925, 926 and lower heaters 912, 927, 928), driving motors 301 to 303, and ultrasonic oscillators 921, 922.

(Process Flow)

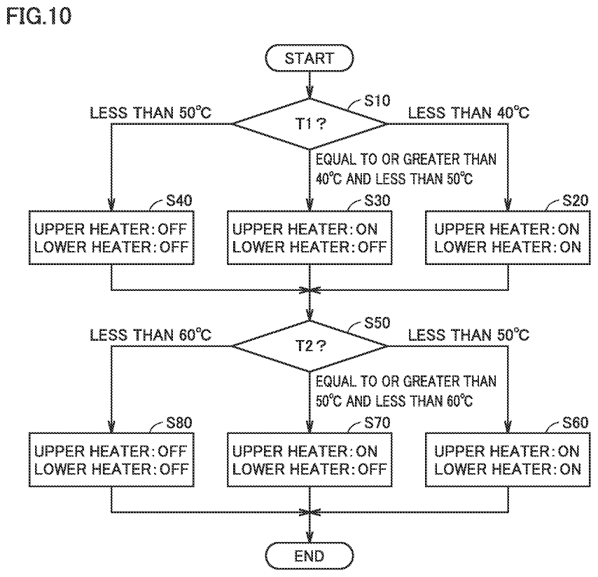

FIG. 10 is a flowchart for control of drying in second drying unit 920 in each of the examples in FIGS. 8 and 9. For example, the process in FIG. 10 is implemented when CPU 101 executes a given program, and started when the leading end portion of the printing medium reaches a prescribed position in the vicinity of the outlet of first drying unit 910 or a prescribed position at the inlet of second drying unit 920.

The control process in steps S10 to S40 in FIG. 10 is the same as that m steps S10 to S40 in FIG. 6. Specifically, in step S10, temperature T1 (the surface temperature of the printing medium) measured by temperature sensor 923 is checked. If temperature T1 is less than 40° C., upper heater 925 and lower heater 927 are turned on in step S20. If temperature T1 is equal to or greater than 40° C. and less than 50° C., upper heater 925 is turned on and lower heater 927 is turned off in step S30. If temperature T1 is equal to or greater than 50° C. upper heater 925 and lower heater 927 are turned off in step S40.

The process in FIG. 10 is predicated on the condition that ultrasonic oscillator 921 applies vibrations to the printing medium introduced into second drying unit 920. In steps S10 to S40, according to the surface temperature of the printing medium measured by temperature sensor 923, it is determined whether heat is applied or not from upper heater 925 and lower heater 927. Then, the control proceeds to step S50.

In step S50, CPU 101 checks a temperature T2 (the surface temperature of the printing medium) measured by temperature sensor 924. If temperature T2 is less than 50° C., CPU 101 causes the control to proceed to step S60. If temperature T2 is equal to or greater than 50° C. and less than 60° C., CPU 101 causes the control to proceed to step S70. If temperature T2 is equal to or greater than 60° C., CPU 101 causes the control to proceed to step S80.

In step S60, CPU 101 turns on upper heater 926 and lower heater 928.

In step S70. CPU 101 turns on upper heater 926 and turns off lower heater 928.

In step S80, CPU 101 turns off upper heater 926 and lower heater 928.

In second drying unit 920, the vibrations from ultrasonic oscillator 922 are utilized for drying the image on the printing medium.

In steps S50 to S80, according to the surface temperature on the printing medium, it is determined whether heat is applied or not from upper heater 926 and lower heater 928 in addition to vibrations from ultrasonic oscillator 922 for drying the image on the printing medium. Then, the process in FIG. 10 ends.

[8. Surface Temperature as Index of Degree of Dryness]

In the process shown in each of FIGS. 6 and 10, according to the surface temperature of the printing medium, it is determined whether heat is used or not in addition to vibrations for drying in second drying unit 920. In this example, the surface temperature of the printing medium is utilized as an index of the degree of dryness of the image formed on the printing medium. Image forming apparatus 1 causes first drying unit 910 to dry the image on the printing medium with heat. As described with reference to FIG. 1, the temperature of the image on the printing medium becomes higher as the dryness progresses more.

In image forming apparatus 1, another physical quantity may be utilized as an index of the degree of dryness of the image on the printing medium. An example of another physical quantity is a gloss level of the image. As the amount of liquid contained in the ink forming an image is larger, the gloss level of the image becomes higher. Thus, as the degree of dryness of the image is higher, the gloss level of the image becomes lower. Accordingly, in the process in each of FIGS. 6 and 10, the determination in each of steps S10 and S50 may be made according to the gloss level of the image on the printing medium in place of the temperature of this image.

For example, if the gloss level of the image on the printing medium is relatively high in step S10, the control proceeds to step S20. If the gloss level is relatively low in step S10, the control proceeds to step S40. If the gloss level is intermediate in step S10, the control proceeds to step S30. More specifically, if the gloss level of the image on the printing medium exceeds the first value in step S10, the control proceeds to step S20. If the gloss level is equal to or less than the first value and greater than the second value (the second value corresponds to the gloss level lower than that of the first value) in step S10, the control proceeds to step S30. If the gloss level is equal to or less than the second value in step S10, the control proceeds to step S40.

Also in steps S50 to S80, the control may be performed according to the gloss level of the image on the priming medium as in steps S10 to S40.

[9. Prediction of Degree of Dryness from Image Pattern]

The degree of dryness of the image on the printing medium fed to second drying unit 920 may be predicted from the pattern of the formed image in place of the value measured by the temperature sensor (or a glossmeter).

When image forming device 200 forms a color image selectively utilizing four types of colors of ink including yellow (Y), magenta (M), cyan (C), and black (K), the portion formed with a greater number of types of ink is different in amount of liquid content predicted after drying in first drying unit 910 (that is, the degree of drying progress) from the portion formed with a fewer number of types of ink More specifically, the portion formed with a greater number of types of ink is predicted to contain more liquid component after drying by first drying unit 910 than the portion formed with a fewer number of types of ink. Thus, based on the type of ink used to form an image on the printing medium, CPU 101 may determine whether each heater is turned on or off in second drying unit 920. CPU 101 may determine whether the heater is turned on or off for each printing medium, or may determine whether the heater is turned on or off for each portion of a printing medium.

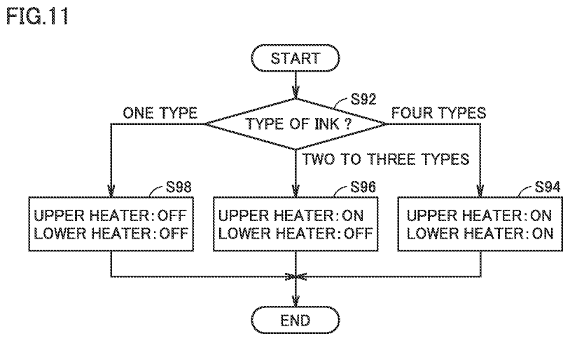

FIG. 11 shows an example of a process performed by CPU 101 for controlling ON/OFF of the heater in second drying unit 920 in a modification (3). FIG. 11 illustrates the process for controlling ON and OFF of the heater for each printing medium. CPU 101 starts the process in FIG. 1, for example, each time a printing medium is introduced into second drying unit 920 in FIG. 4.

In step S92, CPU 101 checks the type of ink used for forming an image on the printing medium introduced into second drying unit 920. When four types of ink are used, CPU 101 causes the control to proceed to step S94. When two types or three types of ink are used, CPU 101 causes the control to proceed to step S96. When one type of ink is used, CPU 101 causes the control to proceed to step S98.

In steps S94, S96 and S98, CPU 101 performs the same control processes as those in steps S20, S30 and S40, respectively, in FIG. 6. Thereby, in step S94, upper heater 925 and lower heater 927 are turned on. In step S96, upper heater 925 is turned on while lower heater 927 is turned off. In step S98, upper heater 925 and lower heater 927 are turned off.

In the example in FIG. 11, as the fewer number of types of ink are used for forming an image, the quantity of heat provided to a printing medium becomes smaller. In other words, the minimum possible heat is applied to a printing medium for drying the image formed on this printing medium.

[10. Prediction of Degree or Dryness from Printing Ratio]

The degree of dryness of the image on the printing medium fed to second drying unit 920 may be predicted from the printing ratio of the formed image (the ratio between the surface onto which ink is applied and the surface area of the printing medium) in place of the value measured by the temperature sensor (or the glossmeter).

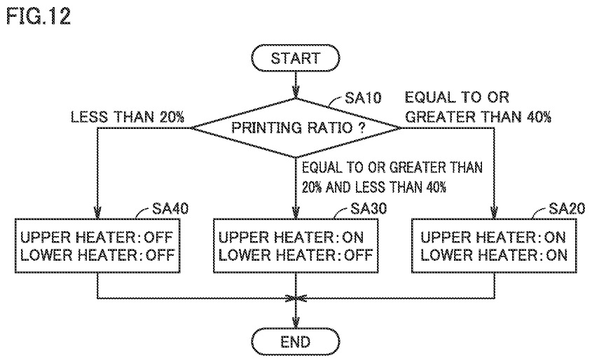

FIG. 12 shows an example of a process performed by CPU 101 for controlling ON/OFF of the heater in second drying unit 920 in a modification (4). CPU 101 starts the process in FIG. 12, for example, each time a printing medium is introduced into second drying unit 920 in FIG. 4.

In step SA10, CPU 101 checks the printing ratio in the printing medium introduced into second drying unit 920. The printing ratio is derived based on the pattern of the image formed on the printing medium, for example. When the printing ratio is equal to or greater than 40%, CPU 101 causes the control to proceed to step SA20. When the printing ratio is equal to or greater than 20% and less than 40%, CPU 101 causes the control to proceed to step SA30. When the printing ratio is less than 20%, CPU 101 causes the control to proceed to step SA40.

In steps SA20, SA30 and SA40, CPU 101 performs the same control processes as those in steps S20, S30 and S40, respectively, in FIG. 6. Thereby, in step SA20 for control in the case of the highest printing ratio, upper heater 925 and lower heater 927 are turned on. In step SA30 for control in the case of the intermediate printing ratio, upper heater 925 is turned on while lower heater 927 is turned off. In step SA40 for control in the case of the lowest printing ratio, upper heater 925 and lower heater 927 are turned off.

In the example in FIG. 12, as the printing ratio on the printing medium is lower, the quantity of heat provided to the printing medium becomes smaller. In other words, the minimum possible heat is applied to a printing medium for drying the image formed on this printing medium.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a drying device that dries ink on a printing medium;
a feeder that feeds, to the drying device, the printing medium on which an image is formed with ink; and
a control device that controls the drying device and the feeder,
wherein the control device causes the drying device to execute:
a first drying process of drying the image on the printing medium fed to the drying device; and,
after the first drying process, a second drying process of applying vibrations to ink that forms the image.

2. The image forming apparatus according to claim 1, wherein, in the first drying process, the ink that forms the image is dried in a manner other than vibrations.

3. The image forming apparatus according to claim 1, wherein the printing medium fed to the drying device is made of a material through which ink does not permeate.

4. The image forming apparatus according to claim 1, wherein the drying device includes at least one of an ultrasonic vibrator and a piezoelectric actuator for applying vibrations in the second drying process.

5. The image forming apparatus according to claim 1, wherein in the second drying process, the control device causes the drying device to further apply heat to the printing medium in a manner according to a predicted degree of dryness of the image on the printing medium introduced into the second drying process.

6. A computer-implemented method of controlling an image forming apparatus, the computer-implemented method comprising:
feeding, to a drying device, a printing medium on which an image is formed with ink; and
in the drying device, performing a first drying process of drying the image on the printing medium; and
in the drying device, performing a second drying process of applying vibrations to ink that form the image after the first drying process.

7. The computer-implemented method according to claim 6, wherein, the first drying process includes drying the ink that forms the image in a manner other than vibrations.

8. The computer-implemented method according to claim 6, wherein the printing medium fed to the drying device is made of a material through which ink does not permeate.

9. The computer-implemented method according to claim 6, wherein the drying device includes at least one of an ultrasonic vibrator and a piezoelectric actuator for applying vibrations in the second drying process.

10. The computer-implemented method according to claim 6, wherein the second drying process includes applying heat to the printing medium in a manner according to a predicted degree of dryness of the image on the printing medium introduced into the second drying process.
